(19) United States
(12) Patent Application Publication
(10) Pub. No.: US 2026/0342003 A1
(43) Pub. Date: Oct. 29, 2026

(54) ELECTRIC CONNECTOR

(71) Applicant: HIROSE ELECTRIC CO., LTD., Kanagawa (JP)

(72) Inventors: Isao TASHIRO, Kanagawa (JP); Akira NAGAMINE, Kanagawa (JP)

(21) Appl. No.: 19/652,421

(22) Filed: Apr. 20, 2026

(30) Foreign Application Priority Data
Apr. 28, 2025 (JP) 2025-073846

(51) Int. Cl. H01R 13/58; B60S 1/02; H01R 12/81; H05B 3/84

(52) U.S. Cl. CPC H01R 13/5812; B60S 1/026; H01R 12/81; H05B 3/84; H01R 2201/26

(57) ABSTRACT

Provided is an electric connector configured to connect a thin electronic component and a cable, including: a terminal configured to be attached to the cable; a housing configured such that the terminal and the thin electronic component are set; and a cover covering the housing, wherein an opening is formed only in one surface of the cover, and a guide portion is formed on an outer peripheral surface of the cover, the opening is configured to allow the thin electronic component and the cable to be led out in a lead-out direction from the opening toward outside of the electric connector, and the guide portion is configured to guide the cable led out in the lead-out direction in an opposite direction to the lead-out direction.

### CROSS-REFERENCE TO RELATED APPLICATION

This application claims priority from Japanese Patent Application No. 2025-073846 filed with the Japan Patent Office on Apr. 28, 2025, the entire content of which is hereby incorporated by reference.

### BACKGROUND

### 1. Technical Field

The present disclosure relates to an electric connector.

### 2. Related Art

Film heaters for automobile windshields or headlights are known (for example, see JP-A-2023-169096). The film heater described in JP-A-2023-169096 performs deicing and anti-fogging of an object to be heated by generating heat. In the electric connector for the film heater, a cable is led out toward a battery from a location different from a location from which the film heater is led out.

### SUMMARY

An electric connector according to an embodiment of the present disclosure is configured to connect a thin electronic component and a cable, and includes: a terminal configured to be attached to the cable; a housing configured such that the terminal and the thin electronic component are set; and a cover covering the housing, wherein an opening is formed only in one surface of the cover, and a guide portion is formed on an outer peripheral surface of the cover, the opening is configured to allow the thin electronic component and the cable to be led out in a lead-out direction from the opening toward outside of the electric connector, and the guide portion is configured to guide the cable led out in the lead-out direction in an opposite direction to the lead-out direction.

### BRIEF DESCRIPTION OF THE DRAWINGS

FIG. 1 is a schematic diagram of a vehicle visibility ensuring apparatus according to a first embodiment.

FIG. 2 is a perspective view of an electric connector according to the first embodiment as viewed obliquely from above.

FIG. 3 is a perspective view of the electric connector according to the first embodiment as viewed obliquely from below.

FIG. 4 is an exploded perspective view of the electric connector according to the first embodiment.

FIGS. 5A and 5B are diagrams illustrating an example of assembly of the electric connector according to the first embodiment.

FIGS. 6A and 6B are diagrams illustrating an example of assembly of the electric connector according to the first embodiment.

FIGS. 7A and 7B are diagrams illustrating an example of cable holding of the electric connector according to the first embodiment.

FIG. 8 is a perspective view of an electric connector according to a second embodiment as viewed obliquely from above.

FIG. 9 is a perspective view of the electric connector according to the second embodiment as viewed obliquely from below.

FIG. 10 is an exploded perspective view of the electric connector according to the second embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In an electric connector described in, for example, JP-A-2023-169096, applying drip-proof measures using potting, a sealing material, or the like to a lead-out location of the film heater and the cable of the electric connector is generally known. However, such a configuration increases the manufacturing cost of the electric connector.

One object of the present disclosure is to provide an electric connector capable of suppressing entry of water droplets and foreign matter while suppressing manufacturing cost.

An electric connector according to one aspect of the present disclosure is an electric connector configured to connect a thin electronic component and a cable, the electric connector including: a terminal configured to be attached to the cable; a housing configured such that the terminal and the thin electronic component are set; and a cover covering the housing, wherein an opening is formed only in one surface of the cover, a guide portion is formed on an outer peripheral surface of the cover, the opening is configured to allow the thin electronic component and the cable to be led out in a lead-out direction from the opening toward outside of the electric connector, and the guide portion is configured to guide the cable led out in the lead-out direction in an opposite direction to the lead-out direction.

According to the electric connector of one aspect of the present disclosure, the thin electronic component and the cable are led out to the outside of the electric connector from the same opening (lead-out opening) provided only in one surface of the cover. Furthermore, the led-out cable is guided by the guide portion in a direction opposite to the lead-out direction from the opening toward the outside of the electric connector. Accordingly, even when the opening is formed only in one surface of the cover, the thin electronic component and the cable can be extended from the electric connector in mutually opposite directions. In addition, since the opening is formed only in one surface of the cover, installing the electric connector in a state in which the opening faces downward relative to the horizontal can suppress entry of water droplets and foreign matter such as dust through the opening. Accordingly, since measures for preventing entry of foreign matter by potting or the like become unnecessary, the manufacturing cost of the electric connector can be reduced.

Embodiments of the present disclosure will be described below. In the drawings described below, the front side is indicated by arrow Fr, the rear side is indicated by arrow Rr, the upper side is indicated by arrow U, the lower side is indicated by arrow Lo, the left side is indicated by arrow L, and the right side is indicated by arrow R.

### First Embodiment

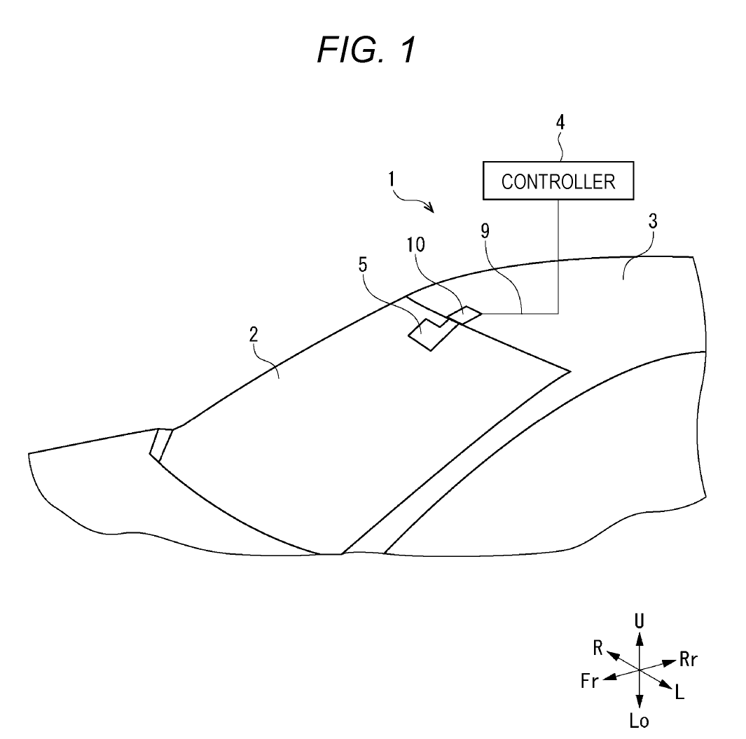

An overview of a vehicle visibility ensuring apparatus employing an electric connector of a first embodiment will be described with reference to FIG. 1. FIG. 1 is a schematic diagram of the vehicle visibility ensuring apparatus according to the first embodiment.

As illustrated in FIG. 1, a film heater 5 of a vehicle visibility ensuring apparatus 1 is attached to an inner side of a windshield 2, and heat generation of the film heater 5 suppresses occurrence of frost, ice adhesion, and fogging on a glass surface. An electric connector 10 is connected to the film heater 5, and a cable 9 extending from a controller 4 is connected to the electric connector 10. A battery (not illustrated) is connected to the controller 4. The controller 4 supplies electric power to the film heater 5 at appropriate timing via the cable 9 and the electric connector 10.

In the vehicle visibility ensuring apparatus 1, the film heater 5 is attached in the vicinity of an upper edge of the windshield 2 where a defroster effect hardly reaches and frost or the like tends to remain. In addition, to avoid obstructing a forward view of a driver, the electric connector 10 is installed above the film heater 5, and the cable 9 connected to the electric connector 10 is routed to pass inside a roof 3 of the vehicle. Specifically, the film heater 5 projects from the electric connector 10 downward toward the windshield 2, and the cable 9 extends from the electric connector 10 upward toward the inside of the roof 3.

In a typical electric connector for a vehicle visibility ensuring apparatus, lead-out openings are formed on one side and on another side of the electric connector. Specifically, the lead-out opening on the one side of the electric connector is directed obliquely forward and downward, and the film heater is led out downward from the lead-out opening on the one side. The lead-out opening on the other side of the electric connector is directed obliquely rearward and upward, and the cable is led out upward from the lead-out opening on the other side. With such a configuration, water droplets due to condensation or the like in the vehicle may enter the electric connector through the obliquely upward lead-out opening on the other side. Therefore, drip-proof measures are generally applied to the electric connector by potting, a sealing material, or the like. However, such a configuration increases the manufacturing cost of the electric connector.

In the electric connector 10 of the first embodiment, a lead-out opening 12 is provided only in one surface of a cover, and the electric connector 10 is installed such that the lead-out opening 12 faces obliquely forward and downward. The film heater 5 and the cable 9 are led out from the single lead-out opening 12 of the electric connector 10 directed obliquely forward and downward. The led-out film heater 5 is attached to the windshield 2, and the led-out cable 9 is folded back obliquely rearward and upward so as to avoid the windshield 2.

Since the electric connector 10 has only the downward lead-out opening 12 in this manner, installing the electric connector 10 such that the lead-out opening 12 faces obliquely forward and downward can suppress entry of water droplets due to condensation or the like into the electric connector 10. Accordingly, drip-proof measures such as potting become unnecessary, and the manufacturing cost of the electric connector 10 is reduced. Furthermore, since the cable 9 does not obstruct the windshield 2, a field of view of the driver can be ensured.

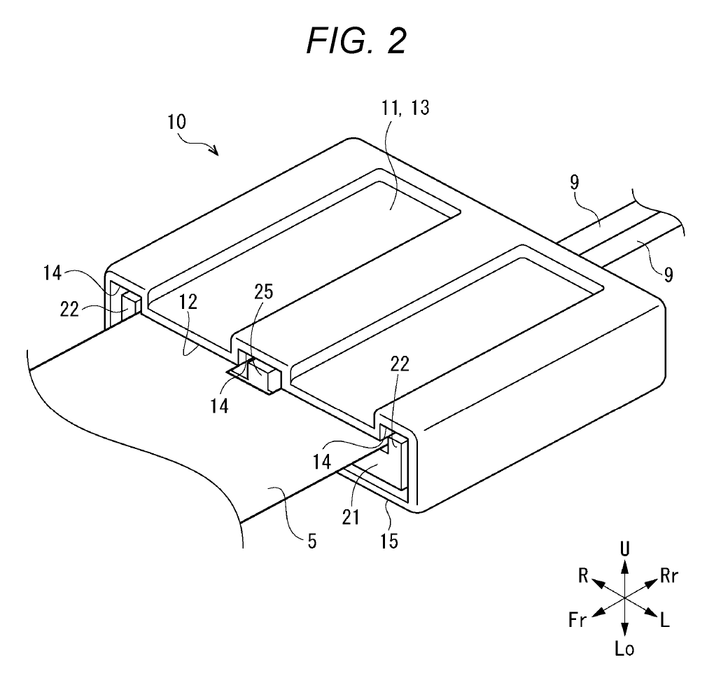

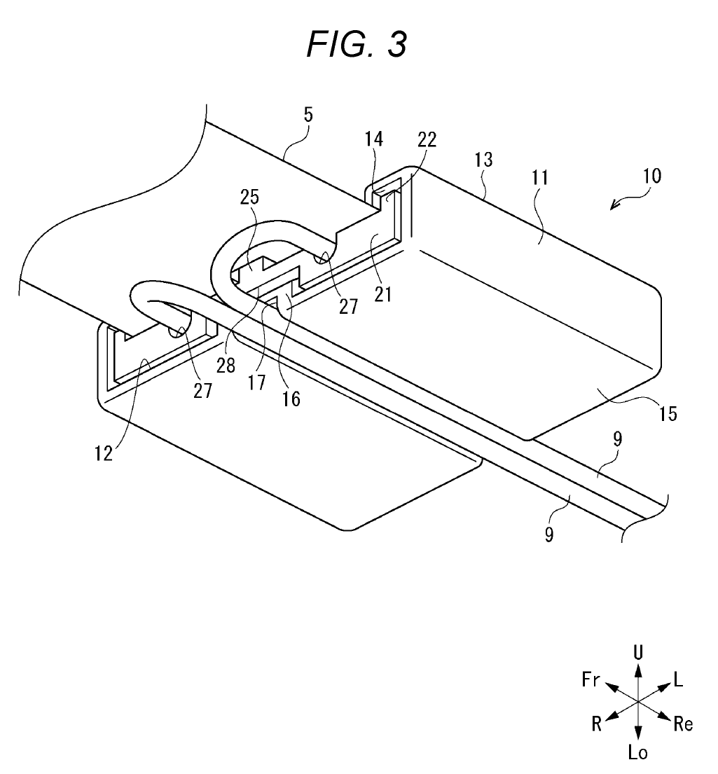

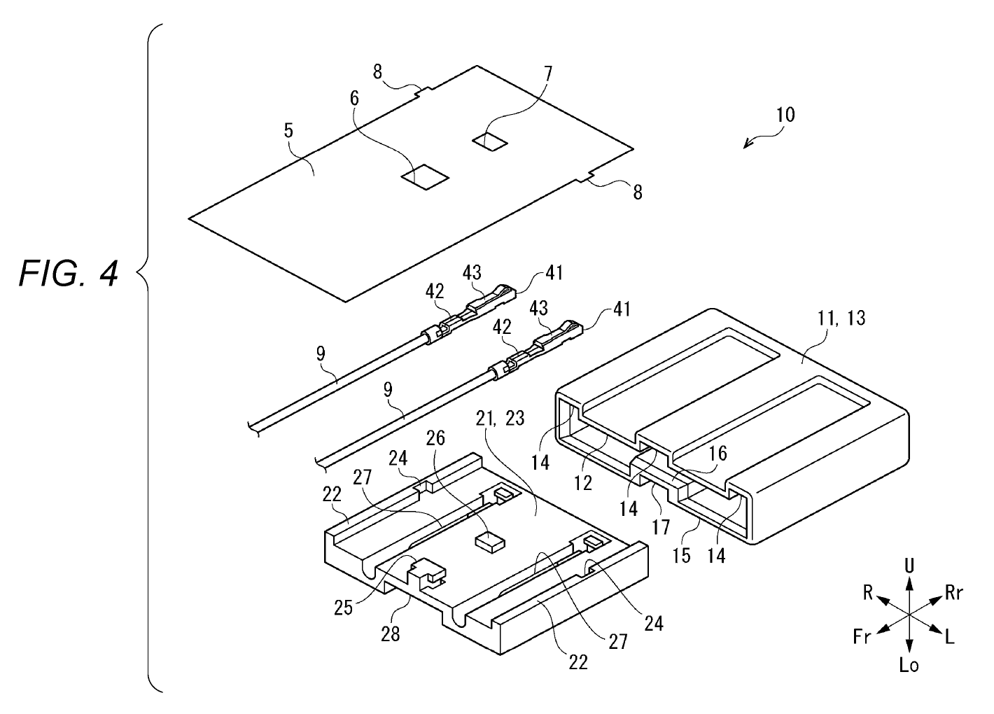

The electric connector will be described below with reference to FIGS. 2-4. FIG. 2 is a perspective view of the electric connector according to the first embodiment as viewed obliquely from above. FIG. 3 is a perspective view of the electric connector according to the first embodiment as viewed obliquely from below. FIG. 4 is an exploded perspective view of the electric connector according to the first embodiment.

As illustrated in FIGS. 2 and 3, the electric connector 10 connects the film heater 5 and a pair of cables 9. The electric connector 10 includes a thin, substantially rectangular parallelepiped-shaped cover 11, a rectangular plate-shaped housing 21, and a pair of terminals 41 (see FIG. 4) connected to the pair of cables 9. Only a front surface (one surface) of the cover 11 is open, and remaining surfaces of the cover 11 are closed. All surfaces other than the front surface of the cover 11 cover the housing 21 so as to wrap the housing 21. The film heater 5 and the terminals 41 of the pair of cables 9 are set in the housing 21, and the film heater 5 and the pair of cables 9 are electrically connected.

The lead-out opening 12 as a single opening is formed in the front surface of the cover 11. The film heater 5 and the pair of cables 9 are led out to the outside through the lead-out opening 12. At the lead-out opening 12, the pair of cables 9 is positioned below the film heater 5. The film heater 5 extends forward from the lead-out opening 12 of the cover 11. The pair of cables 9 led out to the outside is folded back rearward from the lead-out opening 12 of the cover 11, passes along a lower surface of the cover 11, and extends rearward. In the electric connector 10 of the present embodiment, the lead-out opening 12 is formed only in the front surface of the cover 11, and the film heater 5 and the pair of cables 9 extend in mutually opposite directions.

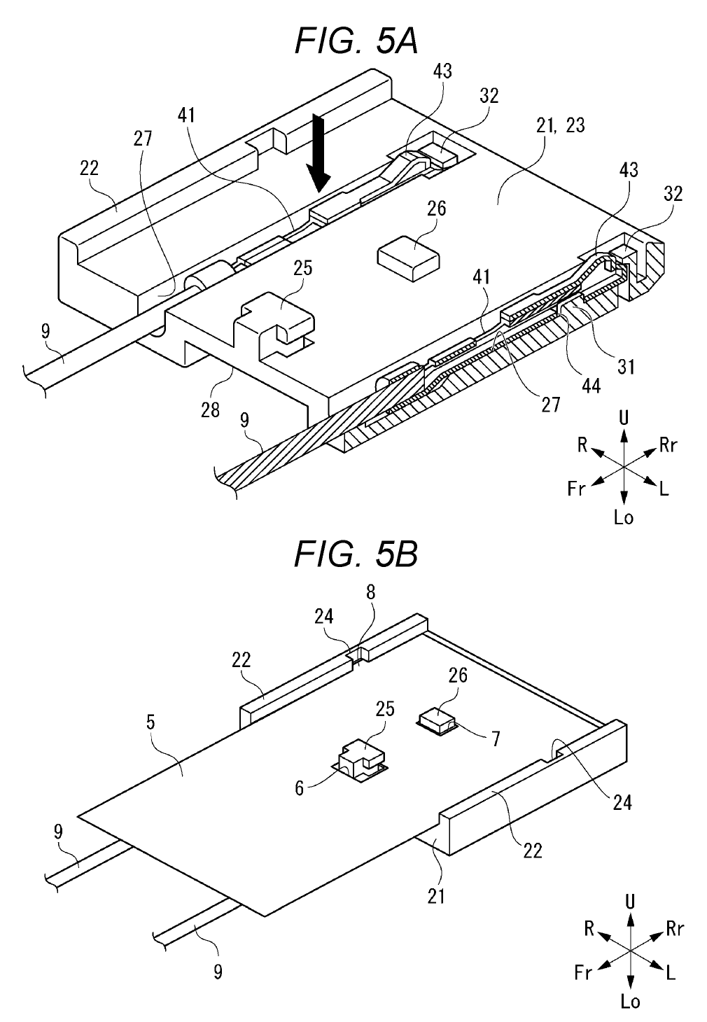

A heat generation function is provided to the film heater 5 by a conductive pattern formed on a base material excellent in heat resistance and insulation. As illustrated in FIG. 4, retaining holes 6 and 7 are formed in front of and behind a central portion of the film heater 5, and a pair of protrusions 8 projects from left and right side edges of the film heater 5. Coating at tip portions of the pair of cables 9 is stripped, and barrels 42 of the pair of terminals 41 are crimped to conductors exposed from the pair of cables 9. Cantilever spring contacts 43 are provided on upper surfaces of the pair of terminals 41, and holding holes 44 (see FIG. 5A) are formed in lower surfaces of the pair of terminals 41.

The housing 21 is formed in a rectangular plate shape from a waterproof resin. A pair of guide ribs 22 projects upward from both side edges of the housing 21. An interval between opposing surfaces of the pair of guide ribs 22 is set to match a width dimension of the film heater 5. An upper surface of the housing 21 serves as an installation surface 23 for the film heater 5. A pair of recesses 24 into which the pair of protrusions 8 of the film heater 5 fits is formed in the pair of guide ribs 22. The recess 24 is formed by partially cutting out a portion of the guide rib 22. Retaining protrusions 25 and 26 project from a center of the installation surface 23 of the housing 21. The retaining protrusions 25 and 26 are configured to be inserted into the retaining holes 6 and 7 of the film heater 5 on the housing 21.

A pair of installation grooves 27 is formed in the installation surface 23 of the housing 21 on left and right sides with the retaining protrusions 25 and 26 interposed therebetween. The pair of installation grooves 27 extends linearly rearward from a front surface of the housing 21. The terminals 41 connected to the pair of cables 9 are set in the pair of installation grooves 27. By forming, in the installation surface 23 on which the film heater 5 is set, the pair of installation grooves 27 in which the pair of terminals 41 is set, a thickness of the housing 21 can be reduced. Accordingly, the electric connector 10 can be made thinner.

A wide groove 28 is formed in a lower surface of the housing 21. The wide groove 28 extends linearly rearward from the front surface of the housing 21 through a center of the lower surface.

The cover 11 is formed in a thin box shape from a waterproof resin. As described above, the lead-out opening 12 is formed in the front surface of the cover 11, and the housing 21 is inserted into the cover 11 through the lead-out opening 12. Therefore, three rows of insertion grooves 14, into which the pair of guide ribs 22 and the retaining protrusions 25 and 26 of the housing 21 are inserted, are formed in a lower surface (inner surface) of an upper wall 13 of the cover 11. A wide ridge portion 16 to be inserted into the wide groove 28 of the housing 21 is formed on an upper surface (inner surface) of a bottom wall 15 of the cover 11. Since an opening shape of the lead-out opening 12 is formed to correspond to a cross-sectional shape of the housing 21, erroneous insertion of the housing 21 into the cover 11 is suppressed.

A guide groove 17 for the cable 9 is formed in a lower surface of the bottom wall 15 of the cover 11. The guide groove 17 is formed by recessing a back side of the ridge portion 16, and the guide groove 17 is configured to be capable of accommodating the pair of cables 9. The guide groove 17 extends linearly from the lead-out opening 12 in the front surface of the cover 11 to a rear surface of the cover 11. At the lead-out opening 12, the film heater 5 is positioned on an upper side, and the pair of cables 9 is positioned on a lower side.

The film heater 5 and the pair of cables 9 are led out from the electric connector 10 in a lead-out direction from the lead-out opening 12 toward the outside of the electric connector 10. Subsequently, the pair of cables 9 is folded back from the lead-out opening 12 toward the guide groove 17 at a center of the lower surface of the cover 11. Furthermore, the pair of cables 9 is guided by the guide groove 17 through the center of the lower surface of the cover 11 in a rearward direction opposite to a forward direction that is the lead-out direction of the film heater 5 and the pair of cables 9.

The pair of cables 9 is led out to the outside and guided from front to rear so as to fit within a dimension (width dimension) in a left-right direction and a dimension in an up-down direction of the housing 21. With such a configuration, the electric connector 10 is reduced in size.

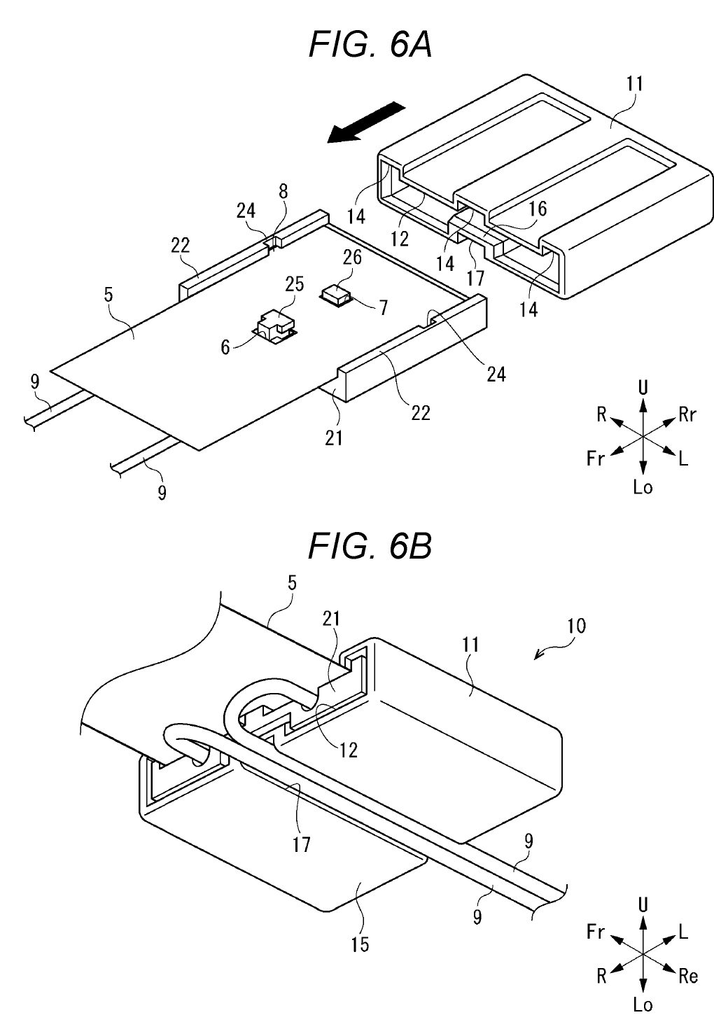

Next, an assembly operation of the electric connector will be described with reference to FIGS. 5A and 5B and FIGS. 6A and 6B. FIGS. 5A and 5B are diagrams illustrating an example of assembly of the electric connector according to the first embodiment. FIGS. 6A and 6B are diagrams illustrating an example of assembly of the electric connector according to the first embodiment.

As illustrated in FIG. 5A, the pair of terminals 41 is attached to tip portions of the pair of cables 9, and the pair of terminals 41 is set with respect to the pair of installation grooves 27 of the housing 21. A pair of holding protrusions 31 projects from groove bottoms of the pair of installation grooves 27. By insertion of the pair of holding protrusions 31 into the holding holes 44 of the pair of terminals 41, the pair of terminals 41 is positioned with respect to the pair of installation grooves 27. In addition, a pair of holding claws 32 is provided at rear end portions of the pair of installation grooves 27. By hooking tip portions of the pair of terminals 41 on the pair of holding claws 32, lifting of the pair of terminals 41 relative to the pair of installation grooves 27 is suppressed. In addition, the spring contacts 43 of the pair of terminals 41 slightly protrude upward from the pair of installation grooves 27.

Next, as illustrated in FIG. 5B, both side edges of the film heater 5 are aligned with opposing surfaces of the pair of guide ribs 22 of the housing 21, and the film heater 5 is set on the installation surface 23 of the housing 21. In this case, by insertion of the pair of protrusions 8 of the film heater 5 into the pair of recesses 24 of the housing 21, the film heater 5 is positioned with respect to the housing 21. By insertion of the retaining protrusions 25 and 26 into the retaining holes 6 and 7 of the film heater 5, the film heater 5 is retained on the housing 21. A pair of pads (not illustrated) on a lower surface of the film heater 5 contacts the spring contacts 43 of the pair of terminals 41 projecting from the installation surface 23 of the housing 21.

Next, as illustrated in FIG. 6A, the cover 11 is attached to the housing 21. In this case, the cover 11 is moved toward the housing 21 from rearward, and the housing 21 is inserted into the lead-out opening 12 of the cover 11. The pair of guide ribs 22 and the retaining protrusions 25 and 26 of the housing 21 slide along the three rows of insertion grooves 14 of the cover 11, and the wide ridge portion 16 of the cover 11 slides along the wide groove 28 of the housing 21 (see FIG. 5A). When the housing 21 is inserted into the cover 11 to a deep side, the film heater 5 and the pair of cables 9 are in a state of being led out forward from the lead-out opening 12 of the cover 11.

Next, as illustrated in FIG. 6B, the pair of cables 9 led out from the lead-out opening 12 of the cover 11 is folded back and routed rearward. After the pair of cables 9 is folded back toward the guide groove 17 in the lower surface of the bottom wall 15 of the cover 11, the pair of cables 9 is guided rearward along the guide groove 17. The pair of cables 9 is accommodated inside the guide groove 17. In the present embodiment, one cable and the other cable of the pair of cables 9 are accommodated inside the guide groove 17 so as to be located at the same position in an up-down direction and to be arranged side by side in a left-right direction. The pair of cables 9 guided rearward along the guide groove 17 is extended to the outside of the electric connector 10 rearward from a rear surface side of the cover 11. By accommodating the pair of cables 9 in the guide groove 17, consistency of a routing path of the pair of cables 9 on the lower surface of the cover 11 is maintained.

The electric connector 10 assembled as described above is installed above the windshield 2 (see FIG. 1) of the vehicle. The lead-out opening 12 of the electric connector 10 is directed downward along a slope of the windshield 2, and the film heater 5 is attached near the upper edge of the windshield 2. In addition, the pair of cables 9 is routed from the electric connector 10 toward the roof 3 (see FIG. 1). Even when water droplets flow down along a glass surface due to condensation or the like in the vehicle, entry of the water droplets through the lead-out opening 12 of the electric connector 10 is suppressed because the lead-out opening 12 is directed downward.

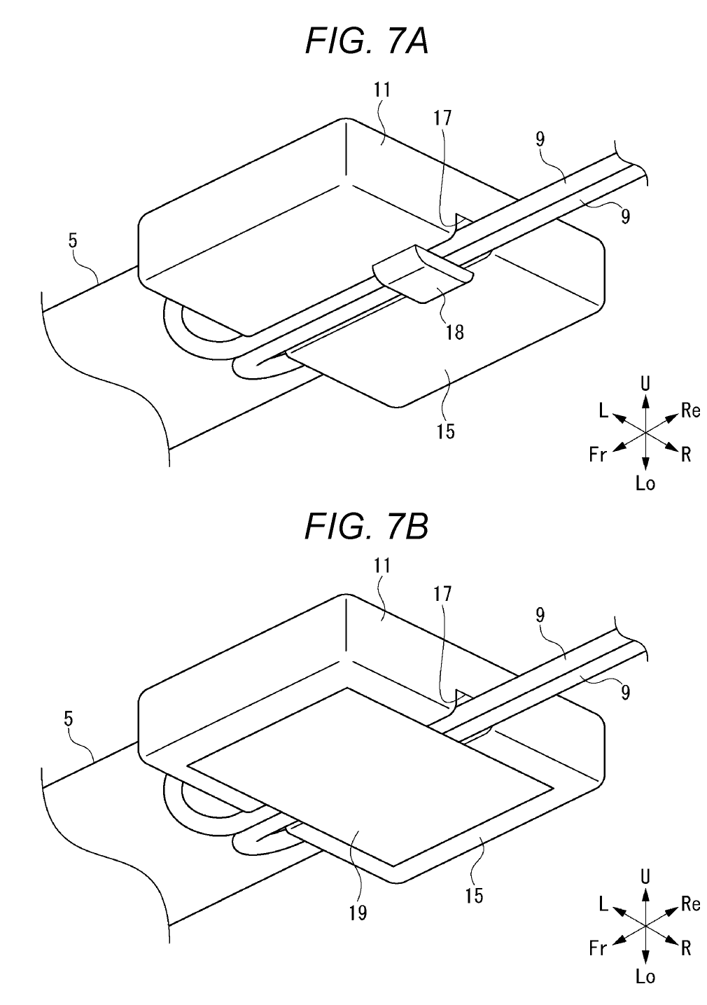

Next, a modification of the present embodiment will be described with reference to FIGS. 7A and 7B.

As illustrated in FIG. 7A, a holding portion 18 may be provided on the lower surface of the bottom wall 15 of the cover 11 of the first embodiment. The holding portion 18 is formed in an arch shape so as to cross the guide groove 17 in a left-right direction, and the holding portion 18 is configured to hold the pair of cables 9 in the guide groove 17. By passing the pair of cables 9 through an inner side (upper side) of the holding portion 18, detachment of the pair of cables 9 from the guide groove 17 is suppressed. In addition, as illustrated in FIG. 7B, by attaching a tape 19 to the lower surface of the bottom wall 15 of the cover 11 of the first embodiment, the tape 19 may hold the pair of cables 9 in the guide groove 17.

In addition, although the above description has described a configuration in which the wide groove 28 and the guide groove 17 are provided at centers of lower surfaces of the housing 21 and the cover 11, respectively, the present embodiment is not limited to the configuration. The wide groove 28 and the guide groove 17 may be provided, on the lower surfaces of the housing 21 and the cover 11, respectively, at positions shifted to a right side or a left side relative to the center.

As described above, according to the first embodiment, even when the lead-out opening 12 is formed only in the front surface of the cover 11, the film heater 5 and the pair of cables 9 can be extended from the electric connector 10 in mutually opposite directions. No opening other than the lead-out opening 12 in the front surface is formed in the cover 11. Therefore, installing the electric connector 10 in a state in which the lead-out opening 12 faces downward relative to the horizontal can suppress entry of water droplets through the lead-out opening 12. In addition, since measures for preventing entry of foreign matter such as potting become unnecessary, the manufacturing cost of the electric connector 10 can be reduced.

### Second Embodiment

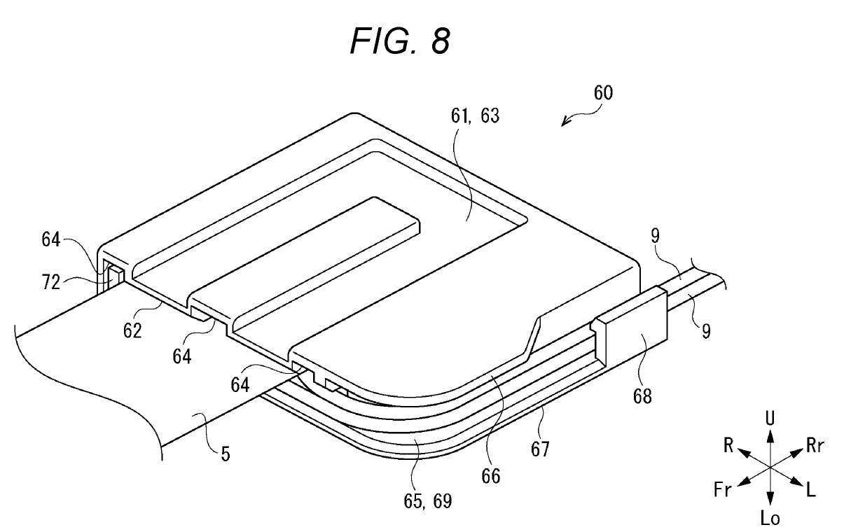

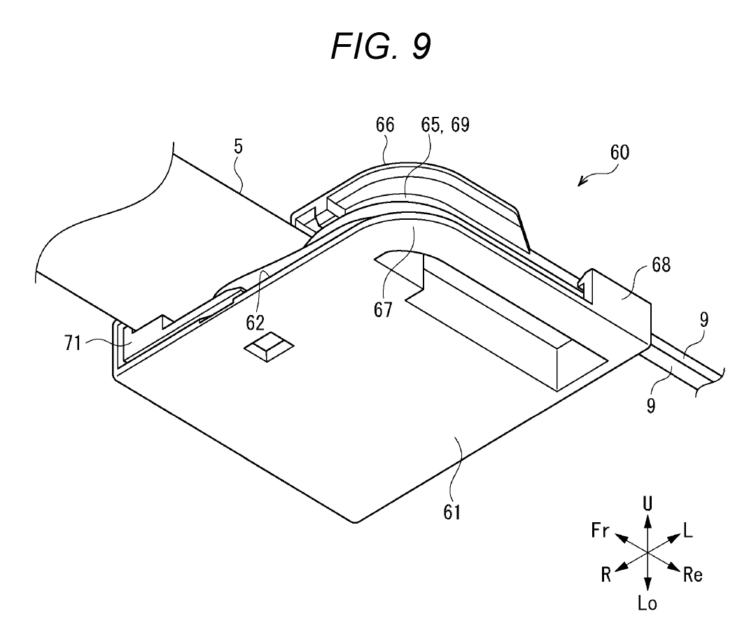

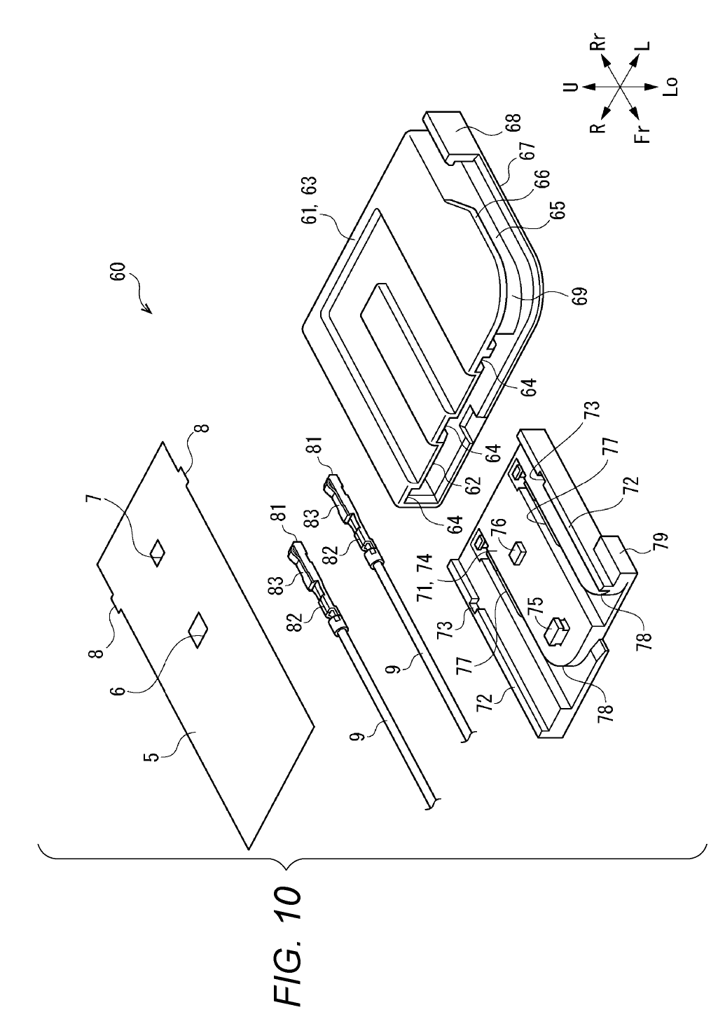

Next, an electric connector according to a second embodiment will be described. FIG. 8 is a perspective view of the electric connector according to the second embodiment as viewed obliquely from above. FIG. 9 is a perspective view of the electric connector according to the second embodiment as viewed obliquely from below. FIG. 10 is an exploded perspective view of the electric connector according to the second embodiment. In the electric connector of the second embodiment, description of configurations similar to those of the electric connector of the first embodiment may be omitted.

As illustrated in FIGS. 8 and 9, an electric connector 60 differs from the electric connector 10 of the first embodiment in a position where a guide groove (guide portion) for guiding the pair of cables 9 is provided.

Only a front surface (one surface) of a cover 61 is open, and remaining surfaces of the cover 61 are closed. All surfaces other than the front surface of the cover 61 cover a housing 71 so as to wrap the housing 71.

A lead-out opening 62 is formed in the front surface of the cover 61, and the film heater 5 and the pair of cables 9 are led out to the outside through the lead-out opening 62. The film heater 5 extends forward from the lead-out opening 62 of the cover 61. The pair of cables 9 led out to the outside is folded back leftward from the lead-out opening 62 of the cover 61, passes along a left side surface of the cover 61, and extends rearward.

As illustrated in FIG. 10, retaining holes 6 and 7 are formed in a central portion of the film heater 5, and a pair of protrusions 8 projects from left and right side edges of the film heater 5. Barrels 82 of a pair of terminals 81 are crimped to tip portions of the pair of cables 9. Cantilever spring contacts 83 are provided on upper surfaces of the pair of terminals 81, and holding holes (not illustrated) are formed in lower surfaces of the pair of terminals 81.

A pair of guide ribs 72 projects upward from both side edges of the housing 71. A pair of recesses 73 is formed in the pair of guide ribs 72. The recess 73 is formed by partially cutting out a portion of the guide rib 72. An upper surface of the housing 71 serves as an installation surface 74 for the film heater 5. Retaining protrusions 75 and 76 project from the installation surface 74 of the housing 71. The retaining protrusions 75 and 76 are configured to be inserted into the retaining holes 6 and 7 of the film heater 5 on the housing 71.

A pair of installation grooves 77 is formed in the installation surface 74 of the housing 71 on left and right sides with the retaining protrusions 75 and 76 interposed therebetween. The pair of installation grooves 77 extends rearward from a front surface of the housing 71. On a front side of the pair of installation grooves 77, a right side surface of each installation groove 77 extends linearly, and a left side surface of each installation groove 77 forms a curved surface 78 curving leftward toward a front side. The curved surfaces 78 of the pair of installation grooves 77 serve as guides when the pair of cables 9 is folded back leftward.

The left installation groove 77 is positioned rearward of the right installation groove 77. In other words, a left side of a front end of the housing 71 is positioned rearward of a right side of the front end of the housing 71. With this configuration, the cable 9 set in the right installation groove 77 can be folded back leftward on an outer side relative to the cable 9 set in the left installation groove 77. In the present embodiment, one cable and the other cable of the pair of cables 9 folded back leftward are folded back so as to be located at the same position in an up-down direction and to be arranged side by side in a left-right direction. A protrusion 79 projects outward from a left side surface on a front side of the housing 71, and the curved surface 78 of the left installation groove 77 is extended by a front surface of the protrusion 79.

The lead-out opening 62 is formed in the front surface of the cover 61. Since an opening shape of the lead-out opening 62 is formed to correspond to a cross-sectional shape of the housing 71, erroneous insertion of the housing 71 into the cover 61 is suppressed. Specifically, three rows of insertion grooves 64 corresponding to the pair of guide ribs 72 and the retaining protrusions 75 and 76 of the housing 71 are formed in a lower surface (inner surface) of an upper wall 63 of the cover 61.

The cover 61 is formed to be wider than the housing 71 in a left-right direction. A guide groove 65 is formed from a left side of the front surface of the cover 61 to the left side surface of the cover 61. The guide groove 65 has a curved surface 69 curving at a corner between the left side of the front surface of the cover 61 and the left side surface of the cover 61. The pair of cables 9 is folded back rearward from the lead-out opening 62 of the cover 61 along the curved surface 69.

The guide groove 65 may be formed from a right side of the front surface of the cover 61 to a right side surface of the cover 61. Specifically, the guide groove 65 may be formed from one surface of the cover 61 in which the lead-out opening 62 is formed to a side surface of the cover 61.

The pair of cables 9 is guided by the guide groove 65 through the left side surface of the cover 61 in a rearward direction opposite to a forward direction that is a lead-out direction of the film heater 5 and the pair of cables 9. The pair of cables 9 is accommodated inside the guide groove 65.

The guide groove 65 is formed by an upper guide wall 66 and a lower guide wall 67. On a rear side of the left side surface of the cover 61, the upper guide wall 66 is cut out in a rightward direction (inward). On the rear side of the left side surface of the cover 61, a holding wall (holding portion) 68 rises from the lower guide wall 67 and holds the pair of cables 9. By holding the pair of cables 9 with the holding wall 68, detachment of the pair of cables 9 from the guide groove 65 is suppressed. In addition, since folding back the pair of cables 9 along the curved surface 69 increases a radius of curvature of a bent portion of the pair of cables 9, breakage of the pair of cables 9 is suppressed.

As described above, also in the second embodiment, installing the electric connector 60 in a state in which the lead-out opening 62 faces downward relative to the horizontal can suppress entry of water droplets through the lead-out opening 62. In addition, since measures for preventing entry of foreign matter such as potting become unnecessary, the manufacturing cost of the electric connector 60 can be reduced.

In the first and second embodiments, an electric connector without potting has been described; however, potting may be performed on an electric connector. In such a case, a space for potting may be secured by extending the cover of the electric connector in a lead-out direction.

As described above, in the first and second embodiments, a guide groove (guide portion) for guiding a cable is formed on an outer peripheral surface of a cover. Specifically, in the first embodiment, the guide groove 17 is formed in the lower surface of the cover as the guide portion, and in the second embodiment, the guide groove 65 is formed in the left side of the front surface and the left side surface of the cover as the guide portion. However, embodiments of the guide portion are not limited to these configurations, and the guide portion only needs to be formed to guide a cable in a direction opposite to a lead-out direction of the film heater and the pair of cables.

In addition, the guide portion need not be a guide groove. For example, the guide portion may be formed as a guide hole that guides a cable in a direction opposite to a lead-out direction of the film heater and the pair of cables.

In addition, in the first and second embodiments, a film heater has been described as an example of a thin electronic component; however, the present disclosure is not limited to the film heater. The thin electronic component may be a flexible printed circuit (FPC), a rigid board, a flat cable, or the like.

In addition, in the first and second embodiments, a configuration has been described in which an electric connector is installed above a vehicle windshield in a state in which a lead-out opening faces downward to suppress entry of water droplets into the lead-out opening of the electric connector; however, an installation location of the electric connector is not particularly limited. The electric connector may be installed at a location where condensation or the like does not occur. In such a case, entry of foreign matter such as dust can be suppressed by directing the lead-out opening of the electric connector downward.

In addition, in the first and second embodiments, a configuration has been described in which an electric connector is installed in a vehicle; however, the electric connector is also applicable to other apparatuses other than vehicles or other conveyances.

A first aspect of the present disclosure is an electric connector (10, 60) configured to connect a thin electronic component (film heater 5) and a cable (9), the electric connector including: a terminal (41, 81) configured to be attached to the cable (9); a housing (21, 71) configured such that the terminal and the thin electronic component are set; and a cover (11, 61) covering the housing, wherein an opening (lead-out opening 12, 62) is formed only in one surface (front surface) of the cover, a guide portion is formed on an outer peripheral surface of the cover, the opening is configured to allow the thin electronic component and the cable to be led out in a lead-out direction from the opening toward outside of the electric connector, and the guide portion is configured to guide the cable led out in the lead-out direction in a direction opposite to the lead-out direction.

With this configuration, the thin electronic component and the cable are led out in the same lead-out direction from the same opening (lead-out opening) provided only in one surface of the cover, and the led-out cable is guided by the guide portion in a direction opposite to the lead-out direction. Therefore, even when the opening (lead-out opening) is formed only in one surface of the cover, the thin electronic component and the cable can be extended from the electric connector in mutually opposite directions. Since no opening other than the opening provided in one surface is formed in the cover, installing the electric connector in a state in which the opening faces downward relative to the horizontal can suppress entry of water droplets and foreign matter such as dust through the opening. In addition, since measures for preventing entry of foreign matter such as potting become unnecessary, the manufacturing cost of the electric connector can be reduced.

A second aspect of the present disclosure is the electric connector of the first aspect, wherein the housing is configured such that the cable is set below the thin electronic component, the guide portion is a guide groove (17) formed in a lower surface of the cover, and the guide groove is configured to guide the cable led out in the lead-out direction in the opposite direction through the lower surface of the cover. With this configuration, the cable is folded back from the lead-out opening of the cover toward the guide groove in the lower surface of the cover. Since the cable is led out so as to fit within a width dimension of the housing, the electric connector can be reduced in size.

A third aspect of the present disclosure is the electric connector of the second aspect, wherein the lower surface of the cover has a holding portion (18), and the holding portion is configured to hold the cable in the guide groove. With this configuration, detachment of the cable from the guide groove is suppressed.

A fourth aspect of the present disclosure is the electric connector of the first aspect, wherein the housing is plate-shaped, the cover is formed wider than the housing, the guide portion is a guide groove (65) formed from the one surface (front surface) of the cover to a side surface of the cover, the guide groove has a curved surface (69) curving at a corner between the one surface of the cover and the side surface of the cover, and the guide groove is configured to guide the cable led out in the lead-out direction in the opposite direction through the side surface of the cover. With this configuration, since the cable is folded back from the lead-out opening of the cover along the curved surface at the corner to increase a radius of curvature of a portion of the cable that is bent during folding back, breakage of the cable is suppressed.

A fifth aspect of the present disclosure is the electric connector of the fourth aspect, wherein the side surface of the cover has a holding portion (holding wall 68), and the holding portion is configured to hold the cable in the guide groove. With this configuration, detachment of the cable from the guide groove is suppressed by the holding portion.

A sixth aspect of the present disclosure is the electric connector according to any one of the first to fifth aspects, wherein the housing has an installation surface (23, 74) configured such that the thin electronic component is set, and an installation groove (27, 77) in which the terminal is set is formed in the installation surface. With this configuration, since a thickness of the housing can be reduced, the electric connector can be made thinner.

A seventh aspect of the present disclosure is the electric connector according to any one of the first to sixth aspects, wherein the thin electronic component is a film heater (5) attached to a vehicle windshield (2), and the opening (lead-out opening 12, 62) is directed downward along an inclination of the windshield. With this configuration, even when water droplets flow down along a glass surface of the windshield due to condensation or the like in the vehicle, entry of the water droplets through the opening can be suppressed because the opening of the electric connector is directed downward.

Embodiments of the present disclosure are not limited to the first and second embodiments described above. The first and second embodiments described above and modifications thereof may be combined wholly or partially.

In addition, the technology of the present disclosure is not limited to the above embodiments, and various changes, substitutions, and modifications may be made within a scope not departing from the gist of the technical idea. Furthermore, if the technical idea can be implemented in another manner by technological progress or another derived technology, implementation may be performed using the manner. Accordingly, the scope of claims covers all embodiments that can fall within the scope of the technical idea.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electric connector configured to connect a thin electronic component and a cable, comprising:
a terminal configured to be attached to the cable;
a housing configured such that the terminal and the thin electronic component are set; and
a cover covering the housing,
wherein an opening is formed only in one surface of the cover, and a guide portion is formed on an outer peripheral surface of the cover,
the opening is configured to allow the thin electronic component and the cable to be led out in a lead-out direction from the opening toward outside of the electric connector, and
the guide portion is configured to guide the cable led out in the lead-out direction in an opposite direction to the lead-out direction.

2. The electric connector according to claim 1, wherein the housing is configured such that the cable is set below the thin electronic component,
the guide portion is a guide groove formed in a lower surface of the cover, and
the guide groove is configured to guide the cable led out in the lead-out direction in the opposite direction through the lower surface of the cover.

3. The electric connector according to claim 2, wherein the lower surface of the cover has a holding portion, and the holding portion is configured to hold the cable in the guide groove.

4. The electric connector according to claim 1, wherein the housing is plate-shaped and the cover is formed wider than the housing,
the guide portion is a guide groove formed from the one surface of the cover to a side surface of the cover,
the guide groove has a curved surface curving at a corner between the one surface of the cover and the side surface of the cover, and
the guide groove is configured to guide the cable led out in the lead-out direction in the opposite direction through the side surface of the cover.

5. The electric connector according to claim 4, wherein the side surface of the cover has a holding portion, and the holding portion is configured to hold the cable in the guide groove.

6. The electric connector according to claim 1, wherein the housing has an installation surface configured such that the thin electronic component is set, and an installation groove in which the terminal is set is formed in the installation surface.

7. The electric connector according to claim 1, wherein the thin electronic component is a film heater attached to a vehicle windshield, and the opening is directed downward along an inclination of the windshield.
